(19) United States
(12) Patent Application Publication
(10) Pub. No.: US 2022/0004976 A1
(43) Pub. Date: Jan. 6, 2022

(54) MERCHANDISE MANAGEMENT SYSTEM AND METHOD THEREOF

(71) Applicant: David S. Lapine Co., Inc., Stamford, CT (US)

(72) Inventors: Chetan Shah, Stamford, CT (US); Noah Lapine, Stamford, CT (US); Jennifer McCauliffe-Grant, Stamford, CT (US); Setu Mulpuri, Stamford, CT (US)

(21) Appl. No.: 17/367,535

(22) Filed: Jul. 5, 2021

Related U.S. Application Data
(60) Provisional application No. 63/048,471, filed on Jul. 6, 2020.

(51) Int. Cl. G06Q 10/08; G06Q 30/08; G06Q 30/02; G06Q 30/06

(52) U.S. Cl. CPC G06Q 10/087; G06Q 30/08; G06Q 30/0633; G06Q 10/08345; G06Q 30/0201

(57) ABSTRACT

Disclosed is a merchandise management system and a method. The merchandise management system and a method comprise obtaining a merchandise request data from a user. In one example, the merchandise request data may comprise at least a list of required products, a weightage matrix and data associated with one or more product from the list of required products. Further to obtaining, the merchandise management system and a method comprise receiving a plurality of submissions associated with the one or more products from a plurality of vendors based on the merchandise request data and computing a score for each of the submission based on a merchandise scoring methodology. Subsequently the merchandise management system and a method comprise ranking each of the submission using the score and the weighted matrix

### CROSS-REFERENCE TO RELATED APPLICATION

This application claims the benefit of U.S. Provisional Application No. 63/048,471 filed Jul. 6, 2020, which is incorporated herein by reference in its entirety.

### TECHNICAL FIELD

The present disclosure described herein, in general, relates to merchandise and in particular for managing merchandise procurement.

### BACKGROUND

Promotional merchandise are products branded with a logo or slogan and distributed at little or no cost to promote a brand, corporate identity, or event. Such products, which are often informally called promo products or freebies, are used in marketing and sales. They are given away or sold at a loss to promote a company, corporate image, brand, or event. They are often distributed as handouts at trade shows, at conferences, on sales calls. Generally, companies, and corporations mainly purchase their merchandise through promotional merchandise distributor companies. However, various departments of companies order their promotional merchandise in siloes, using a wide range of vendors for products that vary in quality, quantity, and pricing. As a result, the decentralized spend becomes a challenge for organizations as a whole to manage leading to wasted time, money, and product.

Furthermore users/companies managing the promotional merchandise purchasing using conventional system and methods lack clear briefing and submission processes, quantification of any corresponding project data (projects, submissions, requestors, budgets, timelines, cost savings). Additionally, the convention system and method fail to addressed both brand needs such as a briefing tool, criteria-based submission guidelines, brand resources and assets, along with procurement needs such as pricing, lead times, minimum order quantities, and other item attributes.

### SUMMARY

Before the present merchandise management system(s) and method(s) are described, it is to be understood that this application is not limited to the particular merchandise management system(s) and methodologies described, as there can be multiple possible embodiments which are not expressly illustrated in the present disclosure. It is also to be understood that the terminology used in the description is for the purpose of describing the particular implementations or versions or embodiments only and is not intended to limit the scope of the present application. This summary is provided to introduce aspects related to a merchandise management system and a method. This summary is not intended to identify essential features of the claimed subject matter nor is it intended for use in determining or limiting the scope of the disclosure.

In one implementation, a merchandise management system, a method and a non-transitory computer readable medium embodying a program executable in a computing device for merchandise management are disclosed.

In one aspect, a merchandise management system is disclosed. In one embodiment the merchandise management system comprises a memory; and at least one processor operatively coupled to the memory, the at least one processor configured to obtain a merchandise request data from a user. In one example, the merchandise request data may comprise at least a list of required products, a weightage matrix and data associated with one or more product from the list of required products. Upon obtaining, the at least one processor is configured to receive a plurality of submissions associated with the one or more products from a plurality of vendors based on the merchandise request data and compute a score for each of the submission based on a merchandise scoring methodology and the weighted matrix. Further to computing, the at least one processor is configured to rank each of the submission using the score.

In one aspect, a method for merchandise management is disclosed. In one embodiment, the method comprises the steps of obtaining a merchandise request data from a user. In one example, the merchandise request data may comprise at least a list of required products, a weightage matrix and data associated with one or more product from the list of required products. The method further comprises the steps of receiving a plurality of submissions associated with the one or more products from a plurality of vendors based on the merchandise request data. The method further comprises the steps of computing a score for each of the submission based on a merchandise scoring methodology and the weighted matrix. The method further comprises the steps of ranking each of the submission using the score.

In yet another embodiment of the present invention, a computer program product is provided. The computer program product comprises a non-transitory computer-readable storage medium which stores a set of instructions. The set of instructions, when executed by a computing device, cause the computing device to perform the operations of obtaining a merchandise request data from a user and generating a bid notification comprising an invitation to provide submission, the merchandise request data, and guidelines on submissions. Upon generating, perform the operations of communicating the bid notification to a plurality of vendors and receiving a plurality of submissions associated with the one or more products from the plurality of vendors based on the merchandise request data. Further to receiving, perform the operations of extracting, by the processor, data comprising one or more of a lead time, minimum order quantity, recyclability value, price, type of packaging, and reusability value from each of the submissions and computing a score for each of the submission based on a merchandise scoring methodology, the weighted matrix and the extracted data. Subsequent to computing, perform the operations of ranking each of the submission using the score.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The present disclosure is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a merchandise management system, in accordance with an embodiment of the present subject matter.

FIG. 2 illustrates the merchandise management system, in accordance with an embodiment of the present disclosure.

FIG. 3 illustrates a method for merchandise management in accordance with an embodiment of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any merchandise management system and methods, similar or equivalent to those described herein can be used in the practice or testing of embodiments of the present disclosure, the exemplary, merchandise management system and methods are now described. The disclosed embodiments for merchandise management are merely examples of the disclosure, which may be embodied in various forms.

Various modifications to the embodiment will be readily apparent to those skilled in the art and the generic principles herein may be applied to other embodiments. For example, although the present disclosure will be described in the context of a merchandise management system and a method, it will readily recognize that the method and merchandise management system can be utilized in any situation where there is need to provide filtering and ranking of various submission done by vendors during procurement of merchandise. Thus, the present disclosure is not intended to be limited to the embodiments illustrated but is to be accorded the widest scope consistent with the principles and features described herein.

As described in the previous section, the convention system and methods involve manual process. For example, the manual processes are time consuming because they often involve long processes involving online searches, completing paper based or email requests and manually communicating with multiple suppliers. When data is input manually mistakes occur more frequently, resulting in errors and inefficiencies. Additionally, Measuring ROI of a campaign is also difficult. Often meaningful data is hard to gather and is kept in individual spreadsheets and email folders scattered across the organization. If information about purchases is hard to gather and incomplete, this means there is no spend visibility or control over the promotional goods expenditure. Furthermore, promotional goods and services are single sourced from web searches, online catalogues or catalogues received through the post. Buying in this way means that companies are offered no price leverages and end up paying higher prices. Plus, with this approach to purchases there is no supply chain visibility. Resulting in the risk of reputational damage and supply delays associated with shipping across borders. Moreover, in Complex promotional projects, involving many items, have a greater risk associated with them. As the project becomes more complex, the risks of making poor purchasing decisions, not achieving good value for money and not receiving high quality promotional goods and services are all increased.

In one embodiment of the present subject a merchandise management system and method are disclosed. In the embodiment, initially a merchandise request data is obtained from a user. In one example, the merchandise request data comprises at least a list of required products, a weightage matrix and data associated with one or more product from the list of required products. Upon obtaining, a bid notification comprising an invitation to provide submission, the merchandise request data, and guidelines on submissions is generated. Further to generating, the bid notification is communicated to a plurality of vendors and a plurality of submissions associated with the one or more products from the plurality of vendors are received based on the merchandise request data. Subsequent to receiving, data comprising one or more of a lead time, minimum order quantity, recyclability value, price, type of packaging, and reusability value is extracted from each of the submissions and a score for each of the submission is computed based on a merchandise scoring methodology, the weighted matrix and the extracted data. Finally, each of the submission is ranked using the score.

While aspects of described merchandise management system and method may be implemented in any number of different computing merchandise management systems, environments, and/or configurations, the embodiments are described in the context of the following exemplary merchandise management system.

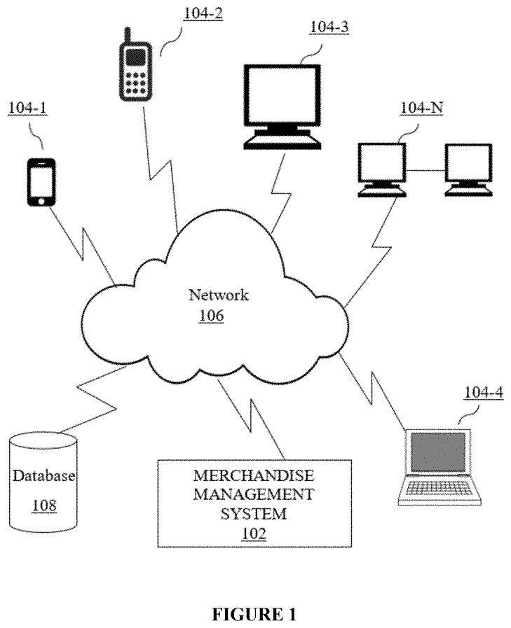

Referring now to FIG. 1, a network implementation 100 of a merchandise management system 102 is disclosed. Although the present disclosure is explained considering that the merchandise management system 102 is implemented on a variety of computing merchandise management systems, such as a laptop computer, a desktop computer, a notebook, a workstation, a mainframe computer, a server, a network server, a cloud-based computing environment and the like. It will be understood that the merchandise management system 102 may be accessed by multiple users through one or more user devices 104-1, 104-2, 104-3, 104-N. In one implementation, the merchandise management system 102 may comprise the cloud-based computing environment in which a user, interchangeably may referred to as a consumer, may operate individual computing merchandise management systems configured to execute remotely located applications. Examples of the user devices 104 may include, but are not limited to, a portable computer, a personal digital assistant, a handheld device, and a workstation. The user devices 104 are communicatively coupled to the merchandise management system 102, a database 108 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In the implementation the merchandise management system 102 initially obtains a merchandise request data from a user. In one example, the merchandise request data may comprise at least a list of required products, a weightage matrix and data associated with one or more product from the list of required products. Upon obtain the merchandise management system 102 may generate a bid notification comprising an invitation to provide submission, the merchandise request data, and guidelines on submissions and communicate the bid notification over the network 106 to a plurality of vendors. Further to communicating, the merchandise management system 102 may receive a plurality of submissions associated with the one or more products from the plurality of vendors based on the merchandise request data and extract data comprising one or more of a lead time, minimum order quantity, recyclability value, price, type of packaging, and reusability value from each of the submissions. Subsequently, the merchandise management system 102 may compute a score for each of the submission based on a merchandise scoring methodology, the weighted matrix and the extracted data and rank each of the submission using the score.

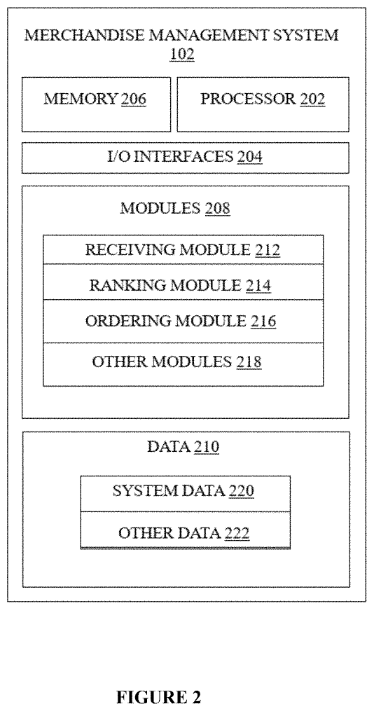

Referring now to FIG. 2, the merchandise management system 102 is illustrated in accordance with an embodiment of the present subject matter. In one embodiment, the merchandise management system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the merchandise management system 102 to interact with the user directly or through the client devices 104. Further, the I/O interface 204 may enable the merchandise management system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 206 may include or be communicatively coupled to modules 208 and data 210.

The modules 208 include routines, programs, objects, components, data structures, etc., which perform particular tasks or implement particular abstract data types. In one implementation, the modules 208 may include a receiving module 212, a ranking module 214, an ordering module 216 and other modules 218. The other modules 218 may include programs or coded instructions that supplement applications and functions of the merchandise management system 102. The modules 208 described herein may be implemented as software modules that may be executed in the cloud-based computing environment of the merchandise management system 102.

The data 210, amongst other things, serves as a repository for storing data processed, received, and generated by one or more of the modules 208. The data 210 may also include a system data 220, and other data 222. The other data 222 may include data generated as a result of the execution of other modules 218, and system data 220 may include data generated as a result of the execution of the receiving module 212, the ranking module 214, the ordering module 216 in the other modules 208. The detailed description of the modules 208 along with other components of the merchandise management system 102 is further explained by referring to FIG. 2.

In one implementation, at first, a user may use the user device 104 to access the merchandise management system 102 via the I/O interface 204. The user may register themselves using the I/O interface 204 in order to use the merchandise management system 102. In one aspect, the user may access the I/O interface 204 of the merchandise management system 102 for customizing the merchandise management system 102, preparing various notification templets and data presentation templets. Further, the merchandise management system 102 may employ the receiving module 212, the ranking module 214, the ordering module 216 effective merchandise management for example procurement and management of promotional merchandise. The detailed working of the plurality of modules is described below.

In one embodiment, the receiving module 212 may obtain a merchandise request (also referred to as merchandise procurement request) data from a user. In one example, the merchandise request data comprises at least a list of required products, a weightage matrix and data associated with one or more product from the list of required products. Construing one example of the merchandise request data, list of required products may be cap, water bottle, t-shirt, others. Further, the Table 1 illustrates an example of a weightage matrix. Furthermore, in the example, the data associated with one or more product may comprise benchmark price such as $5 for cap and $8 for water bottle etc. Other that benchmark pricing data associated with one or more product may also comprise color details, size details etc.

TABLE 1
Weightage Matrix

| Elements | Weight |
|---|---|
| Recyclable Content | 15 |
| Reusable | 10 |
| Packaging | 10 |
| Creative | 5 |
| Smart | 5 |
| Uniqueness | 5 |
| Price | 15 |
| Minimum Order Quantity | 5 |
| Lead Time | 15 |
| Sustainability | 15 |

Upon obtaining, the receiving module 212 may identify if any data is missing from merchandise request data based on comparison of the merchandise procurement request and a predefined templet and communicate a data request notification to the user corresponding to the missing data. In one example, the predefined templet may be generated in real time based on identification of historical merchandise requests similar to the merchandise request and the historical data comprising of vendor feedback, user feedback corresponding to identified historical merchandise requests. In one example, the predefined templet may comprise details such as price, lead time, location of delivery etc.

In one example, the receiving module 212 may generate a second set of data to complete the missing data in the merchandise procurement request based on a response from the user or historical data.

Further, the receiving module 212 may generate a bid notification comprising an invitation to provide submission, the merchandise request data, and a submission guideline and communicate the bid notification to the plurality of vendors and receive a plurality of submissions associated with the one or more products from a plurality of vendors based on the merchandise request data.

Further in the embodiment, the ranking module 214 may extract one or more of a lead time, minimum order quantity, recyclability value, price, type of packaging, and reusability value from each of the submissions. Upon extracting the ranking module 214 may compute a score for each of the submission based on a merchandise scoring methodology.

In one example, the merchandise scoring methodology comprise calculating an item score for a plurality of elements of a submission. Table 2 illustrates and example of the elements and associated value for different status used in the computing the score. Upon calculating the item score for each element, weighted item score is calculated by multiplying the item score its weightage obtained from the weightage matrix. Further, the score is computed by summation of the weighted matrix.

TABLE 2
Element Score Chart

| | | Item |
|---|---|---|
| | | Score |
| Elements | Definition | Value |
| Recyclable | 100% recyclable material | 5 |
| Content | | |
| Recyclable | 80% recyclable material | 3 |
| Content | | |
| Recyclable | 50% recyclable material | 1 |
| Content | | |
| Recyclable | No-recyclable material | — |
| Content | | |
| Reusable | Reusable multiple times | 3 |
| Reusable | One-time Use | 1 |
| Reusable | Reusable multiple times | 3 |
| Reusable | One-time Use | 1 |
| Packaging | Edible Packaging | 5 |
| Packaging | Plant-based | 4 |
| Packaging | Compostable/Bio-degradable | 3 |
| Packaging | Other | — |
| Creative | Subjective | 1 to 5 |
| Smart | Has Sensors | 2 |
| Smart | No Sensors | − |
| Uniqueness | One-of-a-kind Submission | 5 |
| Uniqueness | Stands out amongst similar submission | 3 |
| Uniqueness | Identical to other submissions | — |
| Leadtime | Leadtime is 1-2 Weeks OR 2-3 Weeks | 3 |
| | OR 3-4 Weeks | |
| Leadtime | Leadtime is 4-6 Weeks OR 5-7 Weeks | 2 |
| Leadtime | Leadtime is 8-10 Weeks OR 10-12 Weeks | 1 |
| | OR 13-15 Weeks OR 16-18 Weeks | |
| MOQ | If MOQ is greater than 0 and less than 26 | 3 |
| MOQ | If MOQ is greater than 25 and less than 101 | 2 |
| MOQ | If MOQ is greater than 101 | 1 |

Further in one example, equation 1 illustrates text formula for range of values (rv) scoring type. Further, equation 2 illustrates Formula for Range of Values (Rv) Scoring Type: Furthermore, equation 3 illustrates Formula for Calculating Lead Time.

Item Score=(IF (TYPE_SCORING_SCALE=“Range of values”) AND IF (SCORING_METHODOLOGY=“Element_Scoring) AND IF (Scoring Elements=MEDIAN (RangeFrom: RangeTo), “ScoreValue”, “Move Next”)) (1)

IsC=(IF (TsS=Rv) AND IF (Sm=Es) AND IF (Se=MEDIAN (RangeFrom: RangeTo), “ScoreValue”, “Move Next”)) (2)

IsC=(IF (TsS=Rv) AND IF (Sm=Es) AND IF (Se (Lt)=MEDIAN (0:4), “3”, else) (IF (TsS=Rv) AND IF (Sm=Es) AND IF (Se (Lt)=MEDIAN (3:7), “2”, 1)) (3)

### Wherein:

Type of Scoring Scale—(TsS)
Absolute value—(Av)
Range of values—(Rv)
Variation from Absolute Value—(VaV)
Variation from item category specific bench mark pricing—(VbP)
Relative Ranking Ascending or Descending—(Rr)
Scoring Methodology—(Sm)
Scoring Elements (Es)
Scoring Weightage (Sw)
Scoring Elements (Se)
Price (Pr)
Lead Time (Lt)
Sustainability (Ss)
Item Score (IsC)

Further in one example, equation 4 illustrates the formula for computing item score in a construed example of a Polo Shirt for with the Benchmark Price obtained in the merchandise request data is is15.10 & the price extracted from one of the submissions from one of the vendors (PBQT_1_100) is 34.95.

```
(4)
if (Benchmark > PBQT_1_100)
{
  percentage = round( ((Benchmark − PBQT_1_100)/Benchmark)*100)
  if(percentage>10){
    priceVal = 3
  }elseif(percentage >= 0 && percentage < 11){
    priceVal = 2
  }
}else if(PBQT_1_100 > Benchmark){
  percentage = round( ((PBQT_1_100 − Benchmark)/PBQT_1_100) *
  100 )
  percentage = (((34.95 − 15.10)/34.95)*100) round = 57
  if(percentage > 10 ){
    priceVal = 0
  }elseif(percentage >= 0 && percentage < 11){
    priceVal = 1
  }
}else{
  priceVal = 0
}
Wherein: Benchmark = Benchmark price of product
PBQT_1_100 = Price entered by the vendor while adding product.
```

Further in the embodiment, the ranking module 214 may rank each of the submission using the score and the weighted matrix.

Furthermore, in the embodiment the ordering module 216 may obtain a selection from the user of one or more submission from the plurality of submission and generate a report associated with the selection based on predefined templet.

In one other embodiment, the ordering module 216 may obtain a purchase order from the user associated with one or more submission from the plurality of submission and generate an order cart based on the purchase order, wherein the order cart comprises one or more of delivery addresses, purchase quantity per address, products description. Further the ordering module 216 may compute the total price and communicate the order cart to the vendor associated with the product upon receiving one of a confirmation of order cart and total price or payment of total price from the user. In one example the total price comprises tax corresponding to the one or more delivery address, transportation and delivery cost, and product price.

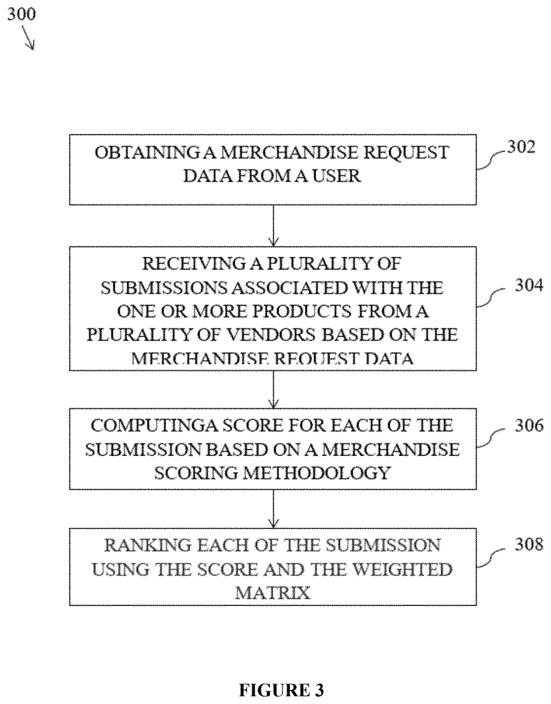

Referring now to FIG. 3, a method 300 for merchandise management is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method can be implemented in any suitable hardware, software, firmware, or combination thereof. However, for ease of explanation, in the embodiments described below, the method 300 may be considered to be implemented in the above described in the merchandise management system 102.

At block 302, a merchandise request data is obtained from a user. In one example, the merchandise request data comprises at least a list of required products, a weightage matrix and data associated with one or more product from the list of required products. In one implementation, the merchandise request data may be obtained by the receiving module 212. Further, the merchandise request data may be stored in the system data 220 by the receiving module 212.

At block 304, a plurality of submissions associated with the one or more products from a plurality of vendors are received based on the merchandise request data. In one implementation, the plurality of submissions may be received by the receiving module 212. Further, the plurality of submissions may be stored in the system data 220 by the receiving module 212.

At block 306 a score for each of the submission is computed based on a merchandise scoring methodology and the weighted matrix. In one implementation, the score for each of the submission may be computed by the ranking module 214. Further, the score for each submission may be stored in the system data 220 by the ranking module 214.

At block 308, each of the submission are ranked using the score. In one implementation, the each of the submission may be ranked by the ranking module 214. Further, the ranking may be stored in the system data 220 by the ranking module 212.

Although implementations for methods and merchandise management systems have been described in language specific to structural features and/or methods, it is to be understood that the appended claims are not necessarily limited to the specific features or methods described. Rather, the specific features and methods are disclosed as examples of implementations of merchandise management.

We claim:

1. A merchandise management system, the merchandise management system comprising:
a memory; and
at least one processor operatively coupled to the memory, the at least one processor configured to
obtain a merchandise request data from a user, wherein the merchandise request data comprises at least a list of required products, a weightage matrix and data associated with one or more product from the list of required products;
receive a plurality of submissions associated with the one or more products from a plurality of vendors based on the merchandise request data;
compute a score for each of the submission based on a merchandise scoring methodology and the weighted matrix; and
rank each of the submission using the score.

2. The merchandise management system as claimed in claim 1, further comprising:
identify one or more missing data from merchandise request data based on comparison of the merchandise procurement request and a predefined templet; and
communicate a data request notification to the user corresponding to the missing data.

3. The merchandise management system as claimed in claim 2, further comprising
generate a second set of data to complete the missing data in the merchandise procurement request based on one of a response from the user and historical data.

4. The merchandise management system as claimed in claim 1, further comprising:
generate a bid notification comprising an invitation to provide submission, the merchandise request data, and a submission guideline; and
communicate the bid notification to the plurality of vendors.

5. The merchandise management system as claimed in claim 1, further comprising
extract one or more of a lead time, minimum order quantity, recyclability value, price, type of packaging, and reusability value from each of the submissions.

6. The merchandise management system as claimed in claim 1, further comprising
obtain a selection from the user of one or more submission from the plurality of submission; and
generate a report associated with the selection based on predefined templet.

7. The merchandise management system as claimed in claim 1, further comprising
obtain a purchase order from the user associated with one or more submission from the plurality of submission;
generate an order cart based on the purchase order, wherein the order cart comprises one or more of delivery addresses, purchase quantity per address, products description;
compute the total price, wherein the total price comprises tax corresponding to the one or more delivery address, transportation and delivery cost, and product price; and
communicate the order cart to the vendor associated with the product upon receiving one of a confirmation of order cart and total price or payment of total price from the user.

8. A method for merchandise management, the method comprising:
obtaining, by a processor, a merchandise request data from a user, wherein the merchandise request data comprises at least a list of required products, a weightage matrix and data associated with one or more product from the list of required products,
receiving, by the processor, a plurality of submissions associated with the one or more products from a plurality of vendors based on the merchandise request data;
computing, by the processor, a score for each of the submission based on a merchandise scoring methodology and the weighted matrix; and
ranking, by the processor, each of the submission using the score.

9. The method as claimed in claim 8, further comprising:
identifying, by the processor, one or more missing data from merchandise request data based on comparison of the merchandise procurement request and a predefined templet; and
communicating, by the processor, a data request notification to the user corresponding to the missing data;

10. The method as claimed in claim 9, further comprising
generating, by the processor, a second set of data to complete the missing data in the merchandise procurement request based on one of a response from the user and historical data.

11. The method as claimed in claim 8, further comprising:
generating, by the processor, a bid notification comprising an invitation to provide submission, the merchandise request data, and guidelines on submissions; and
communicating, by the processor, the bid notification to the plurality of vendors.

12. The method as claimed in claim 8, further comprising
extracting, by the processor, one or more of a lead time, minimum order quantity, recyclability value, price, type of packaging, and reusability value from each of the submissions.

13. The method as claimed in claim 8, further comprising
obtaining, by the processor, a selection from the user of one or more submission from the plurality of submission; and
generating, by the processor, a report associated with the selection based on predefined templet.

14. The method as claimed in claim 8, further comprising
obtaining, by the processor, a purchase order from the user associated with one or more submission from the plurality of submission;
generating, by the processor, an order cart based on the purchase order, wherein the order cart comprises one or more of delivery addresses, purchase quantity per address, products description;
computing, by the processor, the total price, wherein the total price comprises tax corresponding to the one or more delivery address, transportation and delivery cost, and product price; and
communicating, by the processor, the order cart to the vendor associated with the product upon receiving one of a confirmation of order cart and total price or payment of total price from the user.

15. A computer program product comprising a non-transitory computer-readable storage medium storing a set of instructions, which, when executed by a computing device, cause the computing device to perform the operations of:
obtaining a merchandise request data from a user, wherein the merchandise request data comprises at least a list of required products, a weightage matrix and data associated with one or more product from the list of required products;
generating a bid notification comprising an invitation to provide submission, the merchandise request data, and guidelines on submissions;
communicating the bid notification to a plurality of vendors;
receiving a plurality of submissions associated with the one or more products from the plurality of vendors based on the merchandise request data;
extracting data comprising one or more of a lead time, minimum order quantity, recyclability value, price, type of packaging, and reusability value from each of the submissions;
computing a score for each of the submission based on a merchandise scoring methodology, the weighted matrix and the extracted data; and
ranking each of the submission using the score.

16. The computer program product as claimed in claim 15, further comprising:
identifying one or more missing data from merchandise request data based on comparison of the merchandise procurement request and a predefined templet;
communicating a data request notification to the user corresponding to the missing data; and
generating a second set of data to complete the missing data in the merchandise procurement request based on one of a response from the user and historical data.

17. The computer program product as claimed in claim 15, further comprising
obtaining a selection from the user of one or more submission from the plurality of submission; and
generating a report associated with the selection based on predefined templet.

18. The computer program product as claimed in claim 15, further comprising
obtaining a purchase order from the user associated with one or more submission from the plurality of submission;
generating an order cart based on the purchase order, wherein the order cart comprises one or more of delivery addresses, purchase quantity per address, products description;
computing the total price, wherein the total price comprises tax corresponding to the one or more delivery address, transportation and delivery cost, and product price; and
communicating the order cart to the vendor associated with the product upon receiving one of a confirmation of order cart and total price or payment of total price from the user.
